(19) United States
(12) Patent Application Publication
(10) Pub. No.: US 2025/0052361 A1
(43) Pub. Date: Feb. 13, 2025

(54) EXTENDABLE UNIVERSAL SOUND BAR MOUNT

(71) Applicant: Legrand AV Inc., Eden Prairie, MN (US)

(72) Inventors: Stephen Quaglieri, Eden Prairie, MN (US); Adam Maves, Eden, MN (US); Philip Wessberg, Eden Prairie, MN (US)

(21) Appl. No.: 18/720,062

(22) PCT Filed: Dec. 14, 2022
(86) PCT No.: PCT/US2022/052893

§ 371 Date: Jun. 14, 2024

Related U.S. Application Data
(60) Provisional application No. 63/289,496, filed on Dec. 14, 2021.

(51) Int. Cl. F16M 11/04; F16M 11/08; F16M 11/20

(52) U.S. Cl. CPC F16M 11/048; F16M 11/08; F16M 11/2085

(57) ABSTRACT

A soundbar mount that can directionally position a sound bar relative to a wall. The mount includes a wall interface adapted to attach to a wall of a structure, a soundbar interface adapted to attach to a soundbar, and an arm assembly operably coupling the wall interface with the soundbar interface. The arm assembly includes an inner arm pivotally coupled with the wall interlace and an intermediate arm pivotally coupled with the inner arm and the soundbar interface. The soundbar interface can be selectively horizontally shiftable relative to the wall interface such that the soundbar interface is spaced apart from the wall interlace by a selectively variable distance, and a planar front surface of the soundbar interface can be selectively positionable at a variable angle relative to a planar rear surface of the wall interface.

### RELATED APPLICATION

The present application claims the benefit of U.S. Provisional Application No. 63/289,496 filed Dec. 14, 2021, said application being hereby incorporated herein in its entirety by reference.

### TECHNICAL FIELD

The present application relates to mounts for attaching electronic equipment to a wall, and more specifically to mounts for soundbars.

### BACKGROUND

The use of soundbars has become increasingly popular in conjunction with televisions to provide sound quality superior to built-in speakers of the TV while still occupying minimal space. Typically, however, soundbars have been fixed to the wall or other structures with fixed mounts, limiting the versatility of the soundbar. For example, some soundbars now feature directional sound to enhance the listening experience of a user. If the soundbar is mounted to a fixed structure without adjustability, the advantage of directional sound is severely limited or lost. For example, technologies such as Dolby® Atmos have been developed which enable the listener to perceive that they are in a 3-dimensional environment in which particular sounds like a certain musical instrument are pinpointed as to distance and direction from the listener. In order for such technology to be effective, however, the soundbar must be capable of being positioned precisely.

What is needed in the industry is a sound bar mount that addresses the need for accurate directional positioning of a soundbar.

### SUMMARY

As described and depicted herein, embodiments of the present invention address the need in the industry for a soundbar mount that can accurately directionally position a sound bar relative to a wall.

In embodiments of the invention, a soundbar mount includes a wall interface adapted to attach to a wall of a structure, the wall interface presenting a planar rear surface adapted to abut the wall, a soundbar interface adapted to attach to a soundbar, the soundbar interface presenting a planar front surface adapted to receive the soundbar, and an arm assembly operably coupling the wall interface with the soundbar interface. The arm assembly can include an inner arm pivotally coupled with the wall interface and an intermediate arm pivotally coupled with the inner arm and the soundbar interface. The soundbar interface can be selectively horizontally shiftable relative to the wall interface such that the soundbar interface is spaced apart from the wall interface by a selectively variable distance, and the planar front surface of the soundbar interface can be selectively positionable at a variable angle relative to the planar rear surface of the wall interface.

In embodiments, the soundbar mount can include a connecting clamp having an attachment screw, the connecting clamp being engaged with the wall interface, and the attachment screw being selectively operable to enable the connecting clamp to fix the connecting clamp to the wall interface and enable the connecting clamp to be disengaged from the wall interface, the connecting clamp being pivotally coupled to the inner arm of the arm assembly. Further, the soundbar interface can be pivotally coupled to the intermediate arm with an adjustment bolt, the adjustment bolt being selectively rotatable to adjust a vertical position of the soundbar interface relative to the wall interface.

In embodiments, the soundbar interface can further include a horizontally projecting shelf adapted to receive the soundbar.

In further embodiments a soundbar mounting system includes a soundbar mount having a wall interface adapted to attach to a wall of a structure, the wall interface presenting a planar rear surface adapted to abut the wall, a soundbar interface adapted to attach to a soundbar, the soundbar interface presenting a planar front surface adapted to receive the soundbar, and an arm assembly operably coupling the wall interface with the soundbar interface. The arm assembly can include an inner arm pivotally coupled with the wall interface and an intermediate arm pivotally coupled with the inner arm and the soundbar interface. The soundbar interface can be selectively horizontally shiftable relative to the wall interface such that the soundbar interface is spaced apart from the wall interface by a selectively variable distance, and the planar front surface of the soundbar interface can be selectively positionable at a variable angle relative to the planar rear surface of the wall interface.

In embodiments, the soundbar mounting system can include a connecting clamp having an attachment screw, the connecting clamp being engaged with the wall interface, and the attachment screw being selectively operable to enable the connecting clamp to fix the connecting clamp to the wall interface and enable the connecting clamp to be disengaged from the wall interface, the connecting clamp being pivotally coupled to the inner arm of the arm assembly. Further, the soundbar interface can be pivotally coupled to the intermediate arm with an adjustment bolt, the adjustment bolt being selectively rotatable to adjust a vertical position of the soundbar interface relative to the wall interface. In embodiments, the soundbar interface can further include a horizontally projecting shelf adapted to receive the soundbar.

In embodiments, the soundbar mounting system can include a second soundbar mount, the second soundbar mount having a second wall interface adapted to attach to a wall of a structure, the second wall interface presenting a planar rear surface adapted to abut the wall, a second soundbar interface adapted to attach to a soundbar, the second soundbar interface presenting a planar front surface adapted to receive the soundbar, and a second arm assembly operably coupling the second wall interface with the second soundbar interface, the second arm assembly including an inner arm pivotally coupled with the wall interface and an intermediate arm pivotally coupled with the inner arm and the second soundbar interface. The second soundbar interface can be selectively horizontally shiftable relative to the second wall interface such that the second soundbar interface is spaced apart from the second wall interface by a selectively variable distance, and the planar front surface of the second soundbar interface is selectively positionable at a variable angle relative to the planar rear surface of the second wall interface.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a front isometric view of a soundbar mount according to an embodiment of the invention, with a sound bar attached;

FIG. 2 is a front isometric view of an embodiment of the soundbar mount of FIG. 1 with attachment under the soundbar, and with the soundbar depicted in phantom;

FIG. 3 is a front isometric view of an embodiment of the soundbar mount of FIG. 1 with attachment behind the soundbar, and with the soundbar depicted in phantom;

FIG. 4 is a rear isometric view of the sound bar mount of FIG. 3;

FIG. 5 is a top plan view of the sound bar mount of FIG. 2;

FIG. 6 is a partial front isometric view of the sound bar mount of FIG. 2; and

FIG. 7 is a partial rear isometric view of the sound bar mount of FIG. 2.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

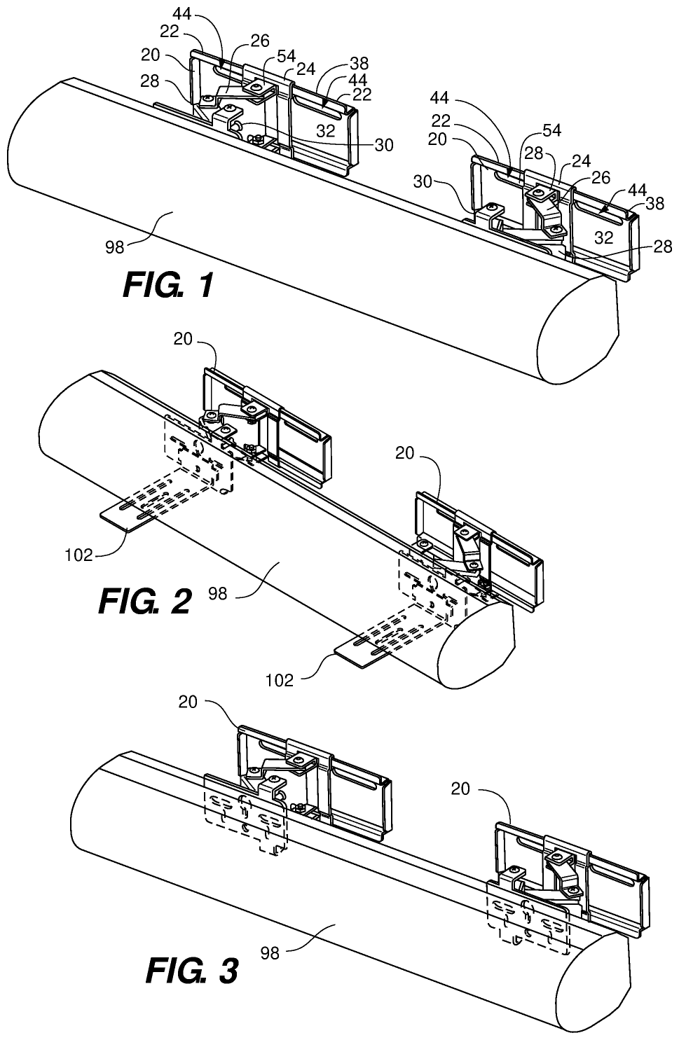

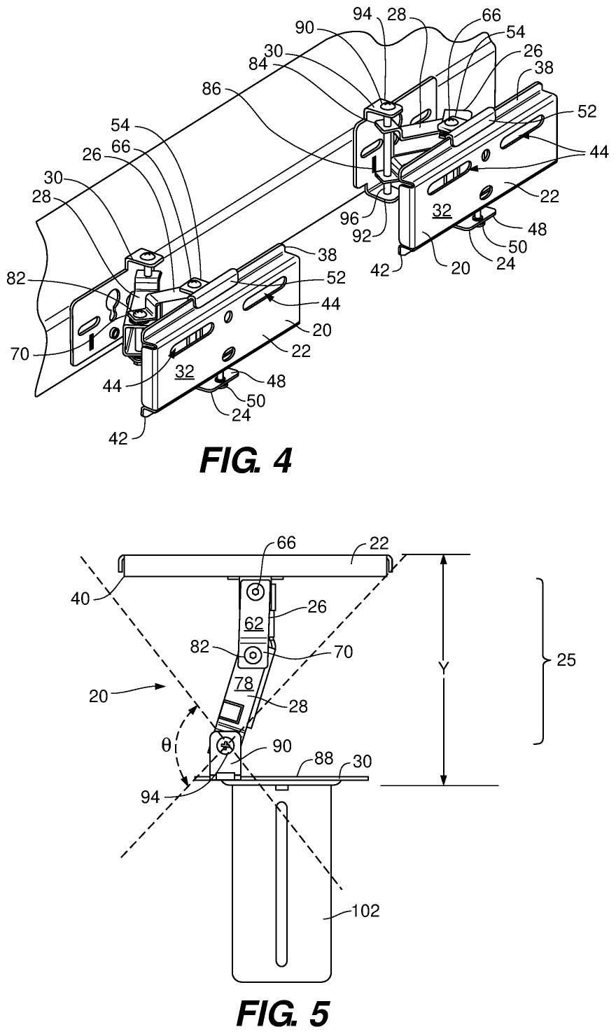

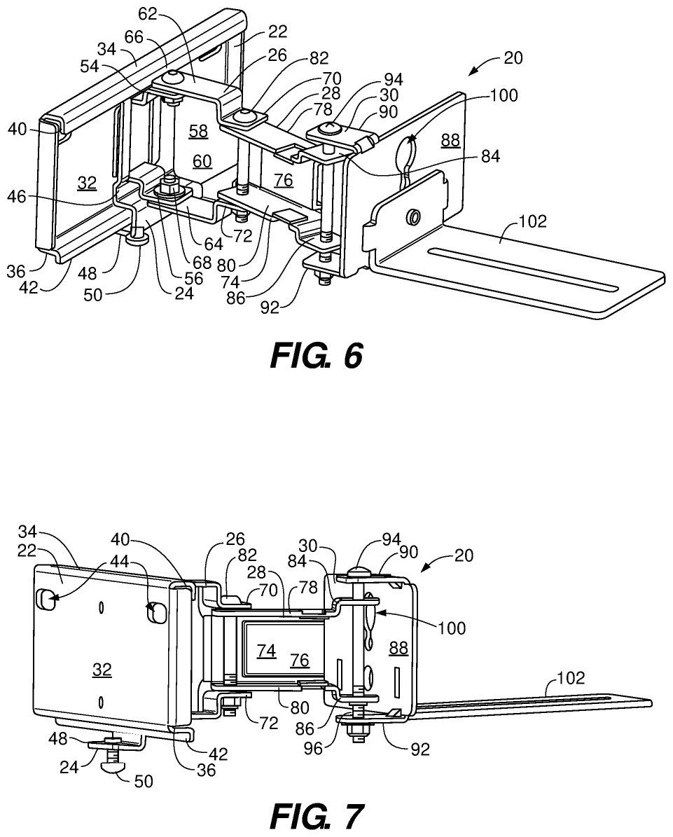

There is depicted in FIGS. 1-7 a soundbar mount 20 according to embodiments of the invention. Soundbar mount 20 generally includes wall interface 22, connecting clamp 24, arm assembly 25 including inner pivot arm 26, intermediate pivot arm 28, and soundbar interface 30. Wall interface 22 has backplane 32 and forwardly projecting top wall 34 and bottom wall 36. Top wall 34 can have an upwardly extending lip 38 as depicted in FIGS. 1-4, or a downwardly extending lip 40 as depicted in FIGS. 5-7. Bottom wall 36 has a downwardly extending lip 42. Backplane 32 defines apertures 44 for receiving fasteners (not depicted) to attach wall interface 22 to the wall of a structure.

Connecting clamp 24 has body portion 46 with lower c-shaped portion 48, which receives attachment screw 50. Body portion 46 can have hook 52, as depicted in FIGS. 1-4, which engages with upwardly extending lip 38. Alternatively, as in the embodiment of FIGS. 5-7, body portion 46 may have an upper portion (not depicted) which fits between backplane 32 and downwardly extending lip 40. Connecting clamp 24 is coupled to wall interface 22 by either hooking hook over upwardly extending lip 38, as in FIGS. 1-4, or fitting the upper portion of body portion 46 between backplane 32 and downwardly extending lip 40, as in FIGS. 5-7. Lower c-shaped portion 48 extends around bottom wall 36. Attachment screw 50 can then be tightened to secure connecting clamp 24 to wall interface 22. Connecting clamp 24 further has forwardly projecting tabs 54, 56.

Inner pivot arm 26 has body portion 58 with sidewall 60, top wall 62, and bottom wall 64. Top wall 62 is pivotally coupled to tab 54 with pivot 66, and bottom wall 64 is pivotally coupled to tab 56 with pivot 68. Body portion 58 has forwardly projecting tabs 70, 72.

Intermediate pivot arm 28 has body portion 74 with sidewall 76, top wall 78, and bottom wall 80. Top wall 78 and bottom wall 80 are pivotally coupled to tabs 70, 72, respectively, with pivot pin 82. Body portion 74 has forwardly projecting tabs 84, 86.

Soundbar interface 30 has interface plate 88 and rearwardly projecting tabs 90, 92. Soundbar interface 30 is pivotally coupled to intermediate pivot arm 28 with adjustment bolt 94 extending through apertures in tabs 84, 86, 90, 92, with the aperture in tab 86 being threaded and engaged with threaded portion 96 of adjustment bolt 94. Adjustment bolt 94 can be rotated relative to tabs 90, 92, causing soundbar interface 30 to translate vertically relative to intermediate arm 28, thereby providing vertical positioning adjustment for soundbar 98 attached to soundbar interface 30.

Interface plate 88 defines keyhole slot 100 for receiving an attachment button (not depicted) on soundbar 98 to attach soundbar 98 directly to soundbar interface 30 as depicted in FIGS. 1 and 3. Alternatively, shelf attachment 102 can be coupled to interface plate 88 to support soundbar 98 from underneath as depicted in FIG. 2.

It will be appreciated that soundbar mount 20 can be used in pairs as depicted in FIGS. 1-4, or could be used individually for a smaller soundbar.

In use, wall interface 22 can be attached to a wall with suitable fasteners. Connecting clamp 24 can then be attached to wall interface 22 as described above, thereby coupling inner pivot arm 26, intermediate pivot arm 28, and soundbar interface 30, to wall interface 22. Soundbar 98 can be attached to soundbar interface 30, and adjustment bolt 94 can be rotated to achieve the desired vertical position of soundbar 98 relative to wall interface 22. With the soundbar mount(s) 20 thus installed, soundbar 98 can be positioned spaced apart from wall interface 22 at any desired variable distance Y away from the wall, and can be selectively angled relative to the wall by any angle θ relative to wall interface 22 by pulling or pushing on soundbar 98, causing inner pivot arm 26 and intermediate pivot arm 28 to articulate. Preferably, wall interface 22, inner pivot arm 26, intermediate pivot arm 28, and soundbar interface 30, are dimensioned such that Y can reach up to 5.6 inches to enable optimal positioning for Dolby® Atmos technology.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A soundbar mount comprising:
a wall interface adapted to attach to a wall of a structure, the wall interface presenting a planar rear surface adapted to abut the wall;
a soundbar interface adapted to attach to a soundbar, the soundbar interface presenting a planar front surface adapted to receive the soundbar; and
an arm assembly operably coupling the wall interface with the soundbar interface, the arm assembly including an inner arm pivotally coupled with the wall interface and an intermediate arm pivotally coupled with the inner arm and the soundbar interface;
whereby the soundbar interface is selectively horizontally shiftable relative to the wall interface such that the soundbar interface is spaced apart from the wall interface by a selectively variable distance, and whereby the planar front surface of the soundbar interface is selectively positionable at a variable angle relative to the planar rear surface of the wall interface.

2. The soundbar mount of claim 1, further comprising a connecting clamp having an attachment screw, the connecting clamp being engaged with the wall interface, and the attachment screw being selectively operable to enable the connecting clamp to fix the connecting clamp to the wall interface and enable the connecting clamp to be disengaged from the wall interface, the connecting clamp being pivotally coupled to the inner arm of the arm assembly.

3. The soundbar mount of claim 1, wherein the soundbar interface is pivotally coupled to the intermediate arm with an adjustment bolt, the adjustment bolt being selectively rotatable to adjust a vertical position of the soundbar interface relative to the wall interface.

4. The soundbar mount of claim 1, wherein the soundbar interface further comprises a horizontally projecting shelf adapted to receive the soundbar.

5. A soundbar mounting system comprising:
a soundbar mount comprising:
a wall interface adapted to attach to a wall of a structure, the wall interface presenting a planar rear surface adapted to abut the wall;
a soundbar interface adapted to attach to a soundbar, the soundbar interface presenting a planar front surface adapted to receive the soundbar; and
an arm assembly operably coupling the wall interface with the soundbar interface, the arm assembly including an inner arm pivotally coupled with the wall interface and an intermediate arm pivotally coupled with the inner arm and the soundbar interface;
whereby the soundbar interface is selectively horizontally shiftable relative to the wall interface such that the soundbar interface is spaced apart from the wall interface by a selectively variable distance, and whereby the planar front surface of the soundbar interface is selectively positionable at a variable angle relative to the planar rear surface of the wall interface.

6. The soundbar mounting system of claim 5, further comprising a connecting clamp having an attachment screw, the connecting clamp being engaged with the wall interface, and the attachment screw being selectively operable to enable the connecting clamp to fix the connecting clamp to the wall interface and enable the connecting clamp to be disengaged from the wall interface, the connecting clamp being pivotally coupled to the inner arm of the arm assembly.

7. The soundbar mounting system of claim 5, wherein the soundbar interface is pivotally coupled to the intermediate arm with an adjustment bolt, the adjustment bolt being selectively rotatable to adjust a vertical position of the soundbar interface relative to the wall interface.

8. The soundbar mounting system of claim 5, wherein the soundbar interface further comprises a horizontally projecting shelf adapted to receive the soundbar.

9. The soundbar mounting system of claim 5, further comprising a second soundbar mount, the second soundbar mount comprising:
a second wall interface adapted to attach to a wall of a structure, the second wall interface presenting a planar rear surface adapted to abut the wall;
a second soundbar interface adapted to attach to a soundbar, the second soundbar interface presenting a planar front surface adapted to receive the soundbar; and
a second arm assembly operably coupling the second wall interface with the second soundbar interface, the second arm assembly including an inner arm pivotally coupled with the wall interface and an intermediate arm pivotally coupled with the inner arm and the second soundbar interface;
whereby the second soundbar interface is selectively horizontally shiftable relative to the second wall interface such that the second soundbar interface is spaced apart from the second wall interface by a selectively variable distance, and whereby the planar front surface of the second soundbar interface is selectively positionable at a variable angle relative to the planar rear surface of the second wall interface.

10. A soundbar system comprising:
a soundbar;
a soundbar mount comprising:
a pair of wall interfaces adapted to attach to a wall of a structure, each wall interface presenting a planar rear surface adapted to abut the wall;
a pair of soundbar interfaces attached to the soundbar; and
a pair of arm assemblies, each arm assembly operably coupling a separate one of the wall interfaces with a separate one of the soundbar interfaces, each arm assembly including an inner arm pivotally coupled with the corresponding wall interface and an intermediate arm pivotally coupled with the inner arm and the corresponding soundbar interface;
whereby the soundbar is selectively horizontally shiftable relative to the wall interfaces such that the soundbar is spaced apart from the wall interfaces by a selectively variable distance, and whereby the soundbar is selectively positionable at a variable angle relative to the planar rear surfaces of the wall interfaces.

11. The soundbar system of claim 10, further comprising a pair of connecting clamps, each connecting clamp having an attachment screw, each connecting clamp being engaged with a separate one of the wall interfaces, and the attachment screws being selectively operable to fix the respective connecting clamp to the wall interface, the connecting clamp being pivotally coupled to the inner arm of the respective arm assembly.

12. The soundbar system of claim 10, wherein each soundbar interface is pivotally coupled to the respective intermediate arm with an adjustment bolt, the adjustment bolts being selectively separately rotatable to adjust a vertical position of the interface relative to the wall interfaces.

13. The soundbar system of claim 10, wherein each soundbar interface further comprises a horizontally projecting shelf adapted to receive the soundbar.

14. The soundbar mount of claim 1, wherein the soundbar interface is coupled to the intermediate arm with a vertical position adjustment mechanism, the vertical position adjustment mechanism being selectively operable to adjust a vertical position of the soundbar interface relative to the wall interface.

15. The soundbar mount of claim 14, wherein the vertical position adjustment mechanism is an adjustment bolt.

16. The soundbar mount of claim 1, wherein the wall interface comprises a backplane with a pair of spaced-apart projecting lips, and a connecting clamp engaged with the lips, the connecting clamp being operably coupled with the inner arm.

17. The soundbar mounting system of claim 5, wherein the soundbar interface is coupled to the intermediate arm with a vertical position adjustment mechanism, the vertical position adjustment mechanism being selectively operable to adjust a vertical position of the soundbar interface relative to the wall interface.

18. The soundbar mounting system of claim 17, wherein the vertical position adjustment mechanism is an adjustment bolt.

19. The soundbar mounting system of claim 5, wherein the wall interface comprises a backplane with a pair of spaced-apart projecting lips, and a connecting clamp engaged with the lips, the connecting clamp being operably coupled with the inner arm.
